(19) United States
(12) Patent Application Publication
(10) Pub. No.: US 2007/0165092 A1
(43) Pub. Date: Jul. 19, 2007

(54) Ink jet recording apparatus

(75) Inventor: Eiichi Kito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/654,654

(22) Filed: Jan. 18, 2007

(30) Foreign Application Priority Data
Jan. 18, 2006 (JP) 2006-009733

(51) Int. Cl. B41J 2/01

(52) U.S. Cl. 347/102

(57) ABSTRACT

There are provided an ink jet recording apparatus which includes an ink jet recording head; an upstream side transport unit arranged upstream of a recording position; a downstream side transport unit arranged downstream of the recording position; a platen arranged to be spaced apart from the ink jet recording head by a predetermined interval necessary for image recording, the platen being movable in a transport direction of the recording sheet between the upstream side transport unit and the downstream side transport unit; a control unit controlling a movement of the platen; and an ink receiver arranged to face the ink jet recording head across an ink ejection region of the ink jet recording head, the ink receiver receiving ink that was ejected from the ink jet recording head and passed across a position where the platen does not exist.

The entire contents of the document cited in this specification are herein incorporated by reference.

### BACKGROUND OF THE INVENTION

This invention belongs to the technical field of an ink jet recording apparatus, and more particularly relates to an ink jet recording apparatus capable of recording an image on the entire surface of a recording sheet without leaving a margin.

In various image recording apparatuses for recording an image on a recording paper and outputting the recorded paper, especially in the case of an image recording apparatus for business purposes in which a large amount of paper is used, the cost of supplying paper by a roll form is lower than that by a cut-sheet form. For example, in ink jet printers for business purposes, a roll-paper loading type is popular. In the roll-paper loading type of the ink jet printer, roll paper is generally drawn and transported to a recording section in a continuous form as it is, and then cut into an output size after image recording, because of the merit of simplification of a sheet transport mechanism at the time of and after the image recording.

However, in the above method, in order to produce a print (i.e., hard copy) on which an image is recorded on the entire surface of a recording sheet, i.e., in order to perform borderless printing, it is required to record images while leaving a margin between them, and cut off the margin after recording the images, which causes waste of paper. In the system of processing a large amount of paper, consideration should be given to the facts that the cost for producing prints increases due to the waste of paper, and a required space for the apparatus increases due to arrangement of a stock unit for unnecessary parts of the paper. Therefore, from this point of view, it is desirable that roll paper be cut before image recording to prepare a cut sheet having a predetermined size, and then perform the image recording on the cut sheet.

However, in the case of image recording in the ink jet system on a cut sheet prepared by cutting roll paper, the following problems arise.

That is, in order to protect a platen supporting a recording sheet from being contaminated with ink even when the borderless printing is performed, a recess (i.e., opening) needs to be formed in the region of the platen facing an ink jet recording head so as to serve as an ink receiver which receives ink ejected outside a recording sheet. However, there is a problem in that the front edge of the recording sheet transported onto the platen is caught in the recess that is formed in the surface of the platen to extend in a width direction of the recording sheet (i.e., direction orthogonal to a transport direction), which would cause jamming. Particularly, a cut sheet prepared by cutting roll paper curls greater in the transport direction, so the front edge of the recording sheet tends to fall into the recess easily.

In order to solve the above problem, the ink jet recording apparatus described in JP 2004-114680 is provided with a support (i.e., guide) that projects from the inner wall surface of an opening of a platen when a recording sheet is transported over the opening so as to support the recording sheet, whereby it is prevented that ink adheres to the platen or the support when performing image recording on the end portions of the recording sheet in the transport direction and that the front edge of the recording sheet is caught in the opening. With this method, jamming can be prevented from occurring at the opening.

### SUMMARY OF THE INVENTION

However, the front edge of the recording sheet is not held during the image recording, so floating of the front edge of the recording sheet due to the curl thereof cannot be suppressed. Therefore, the distance between a recording head and the recording sheet cannot be constant, which leads to degradation of image quality of an image recorded.

The purpose of the present invention is to solve the problems of the above conventional techniques, and to provide an ink jet recording apparatus for performing image recording on a sheet type of recording paper, capable of keeping the distance between a recording sheet and a recording head constant at an image recording section where image recording is performed by a recording head by steadily holding the entire area of the recording sheet including the edges thereof on the platen, thus, capable of recording an image with high quality on the entire surface of the recording sheet, and also capable of performing image recording without a margin (i.e., borderless printing) avoiding contamination of a transport path or the platen.

In order to achieve the above-mentioned object, the present invention provides an ink jet recording apparatus includes: an ink jet recording head; an upstream side transport unit that is arranged upstream of a recording position by the ink jet recording head and transports a recording sheet; a downstream side transport unit that is arranged downstream of the recording position by the ink jet recording head and transports the recording sheet; a platen arranged to be spaced apart from the ink jet recording head by a predetermined interval necessary for image recording, the platen being movable in a transport direction of the recording sheet between the upstream side transport unit and the downstream side transport unit; a control unit controlling a movement of the platen; and an ink receiver arranged to face the ink jet recording head across an ink ejection region of the ink jet recording head, the ink receiver receiving ink that was ejected from the ink jet recording head and passed across a position where the platen does not exist.

Preferably, the control unit controls the movement of the platen according to a position of the recording sheet transported by the upstream side transport unit or the downstream side transport unit.

Preferably, further including a handover guide retractable between the platen and the downstream side transport unit for guiding the recording sheet.

Preferably, the platen comprises an ink receiver that is arranged at a position corresponding to a width of the recording sheet and extends in the transport direction.

Preferably, the platen is divided into regions in a width direction of the recording sheet so as to correspond to recording sheets of different widths, and the platen comprises suction holes for suctioning the recording sheet in the respective regions and suction paths for the suction holes of the respective regions, the suction paths are separated from one another.

Preferably, the ink jet recording head performs division printing, and the control unit determines a position to stop the platen according to a divided position of a division printing control by the ink jet recording head.

Further, preferably, in the above described ink jet recording apparatus, the control unit moves the platen from the position close to the upstream side transport unit to the position at which the platen approximately faces the recording head, when the front edge of the recording sheet in the transport direction enters the downstream side transport unit.

Further, preferably, the control unit moves the platen from the position close to the upstream side transport unit to the position at which the platen approximately faces the recording head, when the front edge of the recording sheet in the transport direction accords with the front edge of the platen in the transport direction.

Further, preferably, the control unit moves the platen to the position close to the downstream side transport unit when the rear edge of the recording sheet in the transport direction accords with the rear edge of the platen in the transport direction.

According to the present invention, in the image recording section where the image recording is performed by the recording head, it is possible to keep the distance between the recording head and the recording sheet about the entire area including the edges constant by steadily holding the entire area of the recording sheet including the edges on the platen. Thus, it is possible to perform the image recording with high quality on the entire surface of the recording sheet, and perform borderless printing without contaminating the transport path or the platen.

### BRIEF DESCRIPTION OF THE DRAWINGS

In the accompanying drawings:

FIG. 1 is a block diagram showing a schematic configuration of one embodiment of an ink jet recording apparatus of the present invention;

FIG. 2 is a perspective view showing a structure of a movable suction stage;

FIGS. 3A to 3D are block diagrams showing recording sheet transport processes during image recording at an image recording section;

FIGS. 4A to 4C are block diagrams showing another configuration of the image recording section and recording sheet transport processes during image recording at the image recording section;

FIGS. 5A to 5E are block diagrams showing a configuration of an image recording section in which an ink head controlled to perform division printing is used and recording sheet transport processes during image recording at the image recording section; and

FIGS. 6A to 6E are block diagrams showing a configuration of an image recording section in which a line head is used and recording sheet transport processes during image recording at the image recording section.

### DESCRIPTION OF THE PREFERRED EMBODIMENTS

An ink jet recording apparatus according to the present invention is explained in detail referring to preferred embodiments shown in the attached drawings.

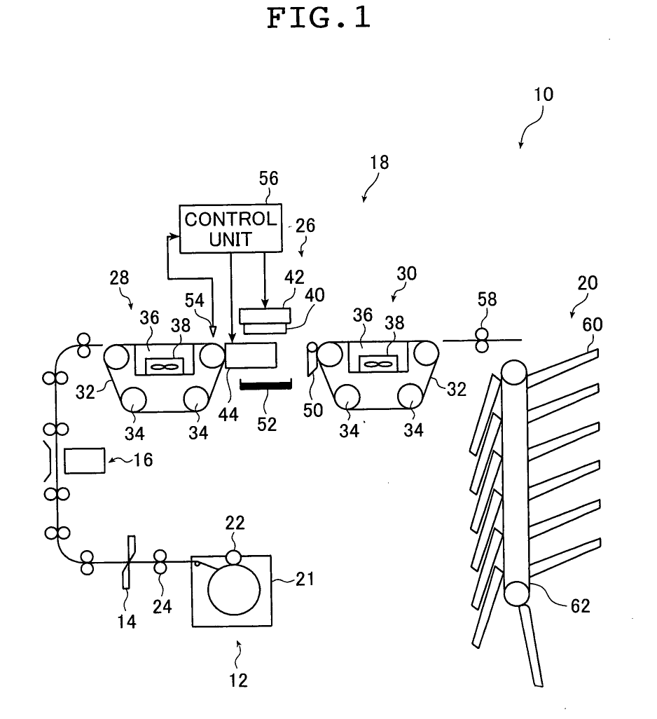

FIG. 1 is a block diagram showing a schematic configuration of one embodiment of the ink jet recording apparatus according to the present invention. In a printer 10 shown in FIG. 1, rolled recording paper is cut prior to image recording to prepare a cut recording sheet A having a predetermined print size, and the image recording is performed by the ink jet system on the entire surface of the recording sheet A, whereby a borderless print is produced and outputted.

The printer 10 includes a paper supplying section 12, a cutter 14, a back-printing unit 16, an image recording section 18, a sorter 20, and transport means for transporting the recording sheet A to each section through a predetermined path. In addition to the components shown in the figure, the printer 10 may comprise various components included in the publicly known printers such as a transport roller pair, a guide roller, a guide member, and a sensor for detecting the recording sheet A if needed.

The paper supplying section 12 supplies the recording paper to prepare the recording sheet A of a predetermined length for print production. The paper supplying section 12 includes a magazine 21 that contains the long rolled recording paper, a feed roller 22 that feeds the rolled recording paper by rotating it, and a drawing roller pair 24 that is arranged near the exit of the magazine 21 and draws the rolled recording paper out of the magazine 21. The paper supplying section 12 loads the rolled recording paper having a width corresponding to a print size.

The cutter 14 is arranged downstream of the paper supplying section 12, and cuts the rolled recording paper in a width direction thereof to prepare the cut recording sheet A.

Upon producing prints, the paper supplying section 12 draws the rolled recording paper out of the magazine 21 by the feed roller 22 and the drawing roller pair 24, and stops the operation of the feed roller 22 and the drawing roller pair 24 at the time when the length of the recording paper downstream from the cutting position by the cutter 14 reaches equal to the length of a print size. When a predetermined length of the recording paper was drawn out of the paper supplying section 12, the cutter 14 is activated so as to prepare the cut recording sheet A having a print size.

The back-printing unit 16 is arranged downstream of the cutter 14. The back-printing unit 16 includes, for example, a dot impact printer, and performs back printing on the back surface (i.e., non-printing surface) of the recording sheet A. Alternatively, the back-printing unit 16 may include an ink jet printer or a thermal printer, and perform back printing by it. The content of the back printing is not specifically limited. For example, various information standardized in photo prints can be recorded.

The image recording section 18 is arranged downstream of the cutter 14. The image recording section 18 includes a recording subsection 26 that performs image recording (i.e., drawing) on the recording sheet A by the ink jet system, an upstream side attraction and transport subsection 28 for transporting the recording sheet A to the recording subsection 26, and a downstream side attraction and transport subsection 30 for transporting the recording sheet A out of the recording subsection 26.

The recording subsection 26 includes a recording unit 42 having an ink head (i.e., recording head) 40 of the ink jet system, a movable attraction stage 44, a handover guide plate 50, an ink receiver 52, a recording sheet detection sensor 54, and a control unit 56 for the recording unit 42, the movable attraction stage 44, and the handover guide plate 50.

The recording subsection 26 ejects ink corresponding to a drive signal based on image data, so that the ejected ink adheres to a predetermined position on the recording sheet A, thereby recording a full-color image on the recording sheet A according to the image data.

In this embodiment, the recording subsection 26 performs the image recording with the ink head 40 of a so-called PWA (Partial Width Array) system. That is, the recording subsection 26 comprises the so-called shuttle type recording unit 42, the upstream side attraction and transport subsection 28 and the downstream side attraction and transport subsection 30 intermittently transport the recording sheet A, and the ink head 40 scans the recording sheet A in a direction (hereinafter referred to as width direction) orthogonal to the transport direction of the recording sheet A in a state where transport of the recording sheet A is stopped, thereby performing two-dimensional image recording on the recording sheet A.

The small ink head 40 is mounted on a carriage (i.e., scanning means) in the recording unit 42 in a state where the nozzle row thereof (i.e., row of nozzles from which ink droplets are ejected) accords with the transport direction of the recording sheet A.

In the recording unit 42, ink cartridges of four colors, i.e., C, M, Y, and K for color image recording, and optionally ink cartridges of intermediate colors or the like are arranged in the with direction (i.e., the ink head 40 moving direction).

The movable attraction stage 44 functions as a platen and serves to hand over the recording sheet A from the upstream side attraction and transport subsection 28 to the downstream side attraction and transport subsection 30.

The movable attraction stage 44 has a support surface which has a width broader than the recording sheet A having a print size and supports the recording sheet A. The movable attraction stage 44 is arranged so that the support surface is in parallel with the ink head 40, whereby it is possible to maintain a predetermined interval needed for the image recording between the support surface and the ink head 40.

In addition, the movable attraction stage 44 is movable by not shown movement means between the upstream side attraction and transport subsection 28 and the downstream side attraction and transport subsection 30 while keeping the support surface 45 for the recording sheet A in the same plane.

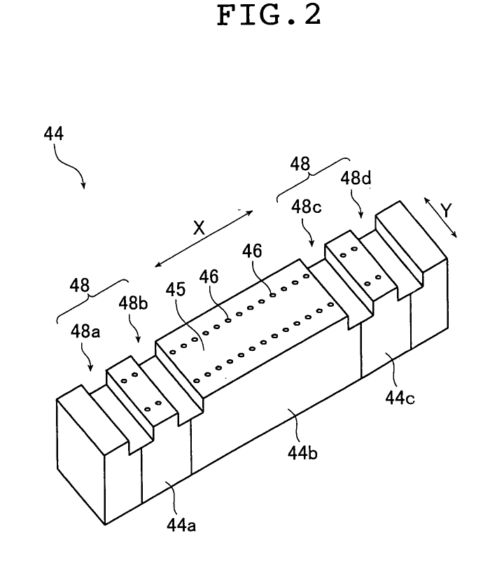

FIG. 2 is a perspective view showing a structure of the movable attraction stage 44, in which X represents the width direction of the recording sheet A, and Y represents the transport direction of the recording sheet A.

A plurality of suction holes 46 are formed in the support surface 45 of the movable attraction stage 44, the support surface 45 is for supporting the recording sheet A. The suction holes 46 are connected to a not shown suction unit, and the recording sheet A is attracted to the support surface 45 due to the suction through the suction holes 46. Thus, the movable attraction stage 44 can prevent the recording sheet A from floating due to the curl thereof and the like, so the distance between the recording sheet A and the ink head 40 can be kept constant, and the recording sheet A can be held without causing any displacement during the image recording. The attraction force is set so that the recording sheet A transported by the upstream side attraction and transport subsection 28 or the downstream side attraction and transport subsection 30 can move on the support surface 45 of the movable attraction stage 44.

Ink receiving grooves 48 (i.e., 48a to 48d) are formed in the support surface 45 of the movable attraction stage 44 at positions corresponding to the edges of the recording sheet A, each of which extends in the transport direction of the recording sheet A (right-to-left direction in FIG. 1). In the embodiment shown in FIG. 2, the ink receiving grooves 48 are formed in the support surface 45, two for each of the right and left sides of the support surface 45 in the width direction, so as to correspond to two kinds of recording sheets of different sizes.

The recording sheet A held by the movable attraction stage 44 is placed such that both edges thereof in the width direction are positioned over the respective ink receiving grooves 48a and 48d, or the respective ink receiving grooves 48b and 48c. Therefore, the ink ejected outside the recording sheet A for producing a borderless print does not adhere to the support surface 45 of the movable attraction stage 44, but is collected into the ink receiving grooves 48. The ink receiving grooves 48 may be connected to a not shown ink collection path, or an ink absorber may be provided at the bottom of each ink receiving groove 48.

In this manner, the ink receiving grooves 48 are formed in the movable attraction stage 44 to correspond to the edges of the recording sheet A in the width direction, so that an image can be printed on the end portions of the recording sheet A in the width direction (i.e., end portions of the recording sheet A extending in the transport direction) without leaving a margin.

The movable attraction stage 44 is partitioned into attraction units 44a, 44b, and 44c with the ink receiving grooves 48a to 48d, and the insides of the attraction units 44a, 44b, and 44c are separated from one another. The suction holes 46 of the respective attraction units 44a, 44b, and 44c are connected to different suction paths, so that the suction operation of each attraction unit can be controlled independently. The movable attraction stage 44 changes the suction region according to the width of the recording sheet A, and closes the suction path of the attraction unit on which the recording sheet A is not placed, whereby it is possible to prevent that unnecessary suction force is exerted by the attraction unit on which the recording sheet A does not exist. In addition, as above, the attraction units 44a, 44b, and 44c are connected to the different suction paths. Therefore, it is possible to prevent leakage of air from the portion on which the recording sheet A does not exist. Thus, the suction force can be stabilized regardless of the size of the recording sheet A to be used.

The handover guide plate 50 is arranged between the movable attraction stage 44 and the downstream side attraction and transport subsection 30. The handover guide plate 50 has a guide surface for the recording sheet A, and is rotatable about one end side thereof proximity to the downstream side attraction and transport subsection 30 as an axis. When the movable attraction stage 44 is placed on the upstream side attraction and transport subsection 28 side, the handover guide plate 50 guides the recording sheet A with the guide surface thereof from the movable attraction stage 44 to the downstream side attraction and transport subsection 30. When the movable attraction stage 44 is moved to the downstream side attraction and transport subsection 30 side, the handover guide plate 50 is retracted from the transport path so as not to prevent the movement of the movable attraction stage 44.

The ink receiver 52 is arranged to face the whole ejection region of the ink head 40. The ink receiver 52 receives the ink that was ejected and passed across the transport path in which the movable attraction stage 44 does not exist. The ink receiver 52 may be connected to a not shown ink collection path, or an ink absorber may be provided at the bottom of the ink receiver 52.

The recording sheet detection sensor 54 is arranged to face an endless belt 32 in the transport path in which the recording sheet A is transported by the upstream side attraction and transport subsection 28. The recording sheet detection sensor 54 detects the front edge of the recording sheet A to be transported to the recording subsection 26 by the upstream side attraction and transport subsection 28, and sends the detection signal to the control unit 56.

The control unit 56 detects the position of the recording sheet A based on the detection signal sent from the recording sheet detection sensor 54, and controls the movements of the movable attraction stage 44 and the handover guide plate 50 according to the position detected. Also, the control unit 56 controls the timing for performing the recording operation by the recording unit 42 based on the detection signal.

The upstream side attraction and transport subsection 28 and the downstream side attraction and transport subsection 30 are for transporting the recording sheet A at the upstream and downstream sides of the image recording section 18, respectively, and have approximately the same configuration.

That is, the upstream side attraction and transport subsection 28 and the downstream side attraction and transport subsection 30 each comprises a belt conveyor including the endless belt 32 having a plurality of through holes and four rollers 34 being looped over by the endless belt 32 and stretching it, and an attraction stage 36 that is located inside the belt conveyor (i.e., endless belt 32) and is in contact with the upper inner surface of the endless belt 32.

The attraction stage 36 is a hollow casing, and has a plurality of through holes in the upper surface. Further, a suction fan 38 is disposed inside the attraction stage 36. When the suction fan 38 is driven, the recording sheet A is attracted to the attraction stage 36, i.e., endless belt 32.

The recording sheet A transported to the upstream side attraction and transport subsection 28 or the downstream side attraction and transport subsection 30 is transported by the belt conveyor including the endless belt 32 and the rollers 34 in a state of being attracted to the endless belt 32 by the driving of the suction fan 38.

Thus, with the upstream side attraction and transport subsection 28 and the downstream side attraction and transport subsection 30, the recording sheet A can be supplied to the recording subsection 26 and performed a sub-scanning transportation in the recording subsection 26 while floating of the recording sheet A due to the curl thereof and the like being prevented from occurring. In addition, the downstream side attraction and transport subsection 30 can transport the recording sheet A to the discharge section (sorter 20) without contacting the surface of the recording sheet A on which an image has been recorded.

The upstream side attraction and transport subsection 28 and the downstream side attraction and transport subsection 30 are driven at the same timing in synchronization with the image recording by the recording subsection 26.

The means for attracting the recording sheet A in the movable attraction stage 44, the upstream side attraction and transport subsection 28, and the downstream side attraction and transport subsection 30 is not limited to the one using suction means, and it is possible to employ electrostatic attraction means using electrostatic force, and other publicly known attraction means.

The recording sheet A having been subjected to the image recording in the image recording section 18 is discharged to the sorter 20 by a discharge roller pair 58. Ink drying means such as a heater or a fan may be provided over the downstream side attraction and transport subsection 30, or between the downstream side attraction and transport subsection 30 and the discharge roller pair 58.

The sorter 20 is a publicly known sorter including a plurality of trays 60 and a rotary driving mechanism 62 for the trays 60. The sorter 20 switches the trays 60 by driving the rotary driving mechanism 62 every time prints for one order are discharged, so that the prints are sorted out and accumulated in units of orders.

Next, the operation of the image recording section 18 of the printer 10 is explained.

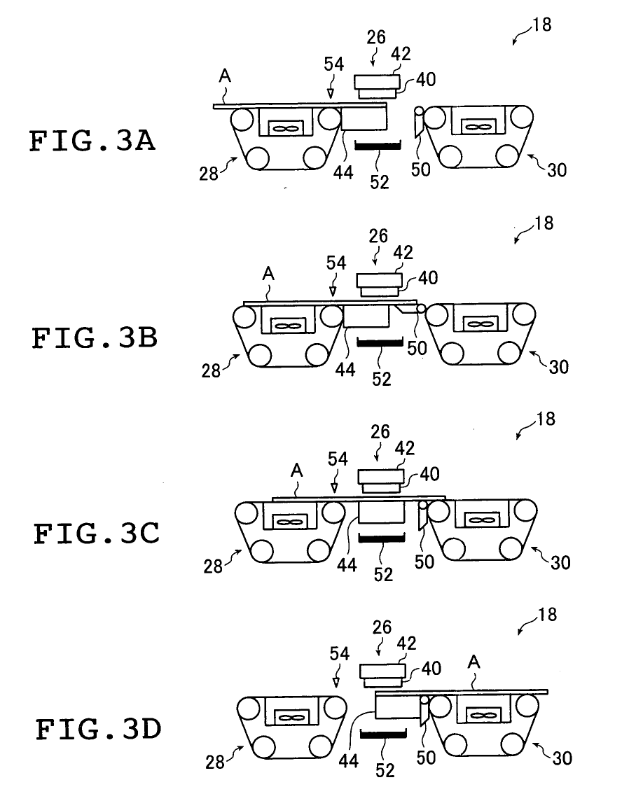

FIGS. 3A to 3D are block diagrams showing transport processes of the recording sheet A during the image recording at the image recording section 18. In the embodiment shown in FIG. 3A to 3D, the size and the arrangement of each component of the image recording section 18 are set to satisfy the following: when the movable attraction stage 44 is at the position closest to the upstream side attraction and transport subsection 28, the downstream edge of the movable attraction stage 44 is within the ink ejection region of the ink head 40, and when the movable attraction stage 44 is at the position closest to the downstream side attraction and transport subsection 30, the upstream edge of the movable attraction stage 44 is within the ink ejection region of the ink head 40.

As shown in FIG. 3A, first, the movable attraction stage 44 is on standby at the position close to the upstream side attraction and transport subsection 28, and the guide surface of the handover guide plate 50 is retracted from the ink ejection region of the ink head 40.

When the recording sheet A is sent to the image recording section 18, the upstream side attraction and transport subsection 28 transports the recording sheet A while attracting it to the transport surface of the endless belt 32. The recording sheet detection sensor 54 detects the front edge of the recording sheet A transported and sends the detection signal thereof to the control unit 56 (refer to FIG. 1).

When the control unit 56 recognizes the position of the recording sheet A based on the detection signal sent from the recording sheet detection sensor 54, and the front edge of the recording sheet A accords with the downstream edge of the movable attraction stage 44, the control unit 56 stops transport of the recording sheet A by the upstream side attraction and transport subsection 28 and starts image recording by the recording unit 42.

The recording unit 42 causes the ink head 40 to eject the ink to the recording sheet A while moving the ink head 40 in the main scanning direction (i.e., direction orthogonal to the transport direction). The ink is ejected from the entire region of the ink head 40 of the recording unit 42, so the ink ejected on the downstream side of the front edge of the recording sheet A is collected in the ink receiver 52. As above, since image recording is started in a state where the front edge of the recording sheet A is within the ink ejection region of the ink head 40, an image can be recorded on the front end portion of the recording sheet A without leaving a margin.

The recording sheet A is attracted to the movable attraction stage 44 due to the suction force, so that the distance between the ink head 40 and the recording sheet A is controlled, whereby an image with stable image quality can be recorded.

The width of the ink ejection region of the ink head 40 in the main scanning direction is slightly broader than the width of the recording sheet A, so the ink ejected outside the edges of the recording sheet A in the width direction is collected in ink receiving grooves 48 of the movable attraction stage 44 (refer to FIG. 2), whereby an image can be recorded on the end portions of the recording sheet A in the width direction without leaving a margin.

After the movement of the ink head 40 in the main scanning direction (i.e., after scanning), the control unit 56 causes the recording sheet A to move by a predetermined amount corresponding to the recording width of the ink head 40 (i.e., nozzle row length in the transport direction) by the upstream side attraction and transport subsection 28, and the ink head 40 is caused to eject the ink again onto the recording sheet A while moving in the main scanning direction. The movement of the ink head 40 in the main scanning direction and the movement of the recording sheet A in the sub scanning direction (i.e., direction orthogonal to the main scanning direction, or transport direction) by the upstream side attraction and transport subsection 28 are repeated alternately, whereby an image is recorded on the recording sheet A.

After the image recording on the front end portion of the recording sheet A is finished, the control unit 56 drives the handover guide plate 50 to arrange it in the transport path as shown in FIG. 3B, so that the handover guide plate 50 supports the recording sheet A. Thereafter, the image recording is continued in this state until the recording sheet A is handed over to the downstream side attraction and transport subsection 30.

As shown in FIG. 3C, after the recording sheet A is handed over to the downstream side attraction and transport subsection 30, the control unit 56 causes the handover guide plate 50 to be retracted from the transport path, and also causes the movable attraction stage 44 to move to the position where it faces the entire ink ejection region of the ink head 40. Thereafter, the image recording is continued in this state.

The movable attraction stage 44 is preferably moved at the time when the recording sheet A is moved in the sub scanning direction for minimizing the effect to the image recording.

When detecting the rear edge of the recording sheet A, the recording sheet detection sensor 54 sends the detection signal to the control unit 56 (refer to FIG. 1).

The control unit 56 receives the detection signal of the rear edge of the recording sheet A from the recording sheet detection sensor 54, and then, causes the movable attraction stage 44 to move to the downstream side attraction and transport subsection 30 side (i.e., downstream side) in synchronization with the movement of the recording sheet A by the upstream side attraction and transport subsection 28 and the downstream side attraction and transport subsection 30. When the movable attraction stage 44 reaches the most downstream side, the upstream edge of the movable attraction stage 44 is within the region where the ink head 40 ejects the ink.

Thereafter, the image recording is continued. When the rear edge of the recording sheet A accords with the upstream edge of the movable attraction stage 44, as shown in FIG. 3D, the image recording by the recording unit 42 is finished. At this time, the upstream edge of the movable attraction stage 44, i.e., the upstream edge (i.e., rear edge) of the recording sheet A is within the ink ejection region of the ink head 40, and the ink is ejected from the entire region of the ink head 40 of the recording unit 42, so the ink ejected on the upstream side of the rear edge of the recording sheet A is collected in the ink receiver 52.

As above, since the image recording is finished in a state where the rear edge of the recording sheet A is within the ink ejection region of the ink head 40, an image can be recorded on the rear end portion of the recording sheet A without leaving a margin.

According to the above method, the movable attraction stage 44 only needs to be moved in three steps, that is, the upstream side, the central region, and the downstream side, so movement control of the movable attraction stage 44 is simple. In the case where the movable attraction stage 44 can move by the length corresponding to the movement of the recording sheet A, the movable attraction stage 44 may be moved to the downstream side from the central region together with the recording sheet A when the rear edge of the recording sheet A accords with the upstream edge of the movable attraction stage 44.

The recording sheet A having an image recorded thereon is transported downstream by the downstream side attraction and transport subsection 30. The movable attraction stage 44 returns to its original position on the upstream side after the recording sheet A is completely transported to the downstream side attraction and transport subsection 30.

As above, it is possible to perform borderless and full surface printing on the cut sheet type of recording sheet A without causing the ink to adhere to the movable attraction stage 44 or the handover guide plate 50.

In the above embodiment, the handover guide plate 50 is arranged near the downstream side attraction and transport subsection 30 between the upstream side attraction and transport subsection 28 and the downstream side attraction and transport subsection 30, and the recording sheet A is handed over to the downstream side attraction and transport subsection 30 by the handover guide plate 50. According to this configuration, the movement control of the movable attraction stage 44 for handing over the recording sheet A can be simple. Further, when an image is recorded on the central portion of the recording sheet A, the movable attraction stage 44 can be positioned to face the entire ink ejection region of the ink head 40. Therefore, the interval between the recording sheet A and the ink head 40 can be maintained at high precision at the time of the image recording, so a high quality image can be recorded with stability.

However, the image recording section 18 may not include the handover guide plate 50.

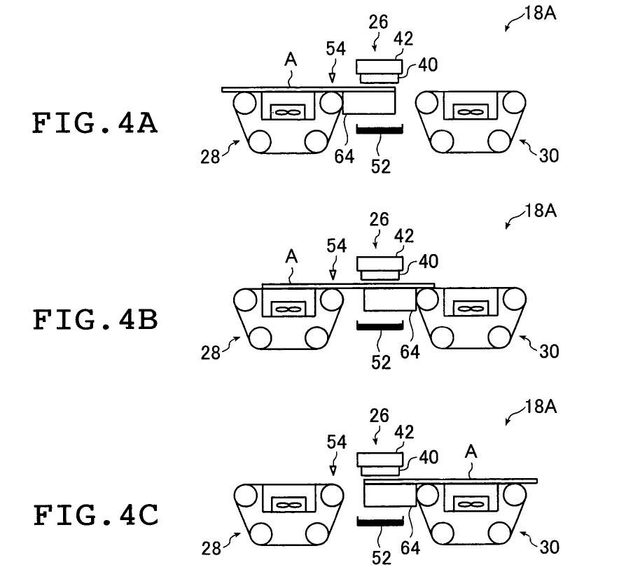

FIGS. 4A to 4C are block diagrams showing another configuration of the image recording section 18 and transport processes of the recording sheet A during the image recording. In an image recording section 18A in FIGS. 4A to 4C, when a movable attraction stage 64 is located on the most upstream side (i.e., on the upstream side attraction and transport subsection 28 side), the downstream edge of the movable attraction stage 64 is within the ink ejection region of the ink head 40, and when the movable attraction stage 64 is located on the most downstream side (i.e., on the downstream side attraction and transport subsection 30 side), the upstream edge of the movable attraction stage 64 is within the ink ejection region of the ink head 40 so that an upstream portion of the ink head 40 with a length of approximately one nozzle (one dot) is on the upstream side of the rear edge of the movable attraction stage 64.

With this configuration, as shown in FIG. 4A, when the front edge of the recording sheet A accords with the downstream edge of the movable attraction stage 64, the recording unit 42 starts the image recording, and the recording sheet A is transported for the sub scanning by the upstream side attraction and transport subsection 28 and the movable attraction stage 64.

When the movable attraction stage 64 is moved to the downstream side attraction and transport subsection 30 side, the recording sheet A is handed over to the downstream side attraction and transport subsection 30 as shown in FIG. 4B. The movable attraction stage 64 stops at the downstream side attraction and transport subsection 30 side. At this time, the upstream end portion of the movable attraction stage 64 is positioned to face almost the entire ink ejection region of the ink head 40, so the recording sheet A can be supported at the image recording position while keeping its surface flat.

When the rear edge of the recording sheet A accords with the upstream edge of the movable attraction stage 64, the image recording onto the recording sheet A is finished, and the ink ejection from the ink head 40 is stopped. Thereafter, the recording sheet A is transported downstream by the downstream side attraction and transport subsection 30.

In this embodiment, the ink is ejected even to the outside of the front and rear edges of the recording sheet A, so an image can be recorded on the recording sheet A without leaving a margin. Also, the movable attraction stage 64 is prevented from being contaminated due to the ink ejected.

Next, still another example of the configuration of the image recording section 18 and the operation thereof will be explained.

In the ink jet printer, there is known a technique in that nozzles of an ink head are divided in the transport direction of a recording sheet into division parts, ink is ejected from each division part independently, and the recording sheet is transported in the sub scanning direction by the length of the division part of the ink head, whereby the same line on the recording sheet is subjected to the multiple image recording of the number of times of the division parts. The division printing control allows an image to be recorded with a higher resolution than the resolution (i.e., the dot-pitch) of the ink head.

However, in the division printing control, one line on a recording sheet is subjected to printing a plurality of times at different positions by the division parts of the ink head. Thus, in order to record an image on a recording sheet without leaving a margin on the front and rear end portions thereof by using an ink jet head which performs the division printing control in a conventional printer having a fixed platen, ink receivers extending in the width direction need to be formed for each division part in the recording sheet supporting surface of the platen, which is not practical. For example, if a groove extending in the width direction is formed in the platen, problems arise such as that flatness of the sheet cannot be maintained due to failure to support the sheet at the groove, and that the edge of the sheet is caught in the groove.

In contrast to this, the ink jet recording apparatus of the present invention comprises the platen (i.e., movable attraction stage) movable in the transport direction of the recording sheet with respect to the ink head, thus enabling even the recording apparatus utilizing an ink head that performs the division printing control to perform borderless printing while protecting the platen from being contaminated with ink and ensuring image quality.

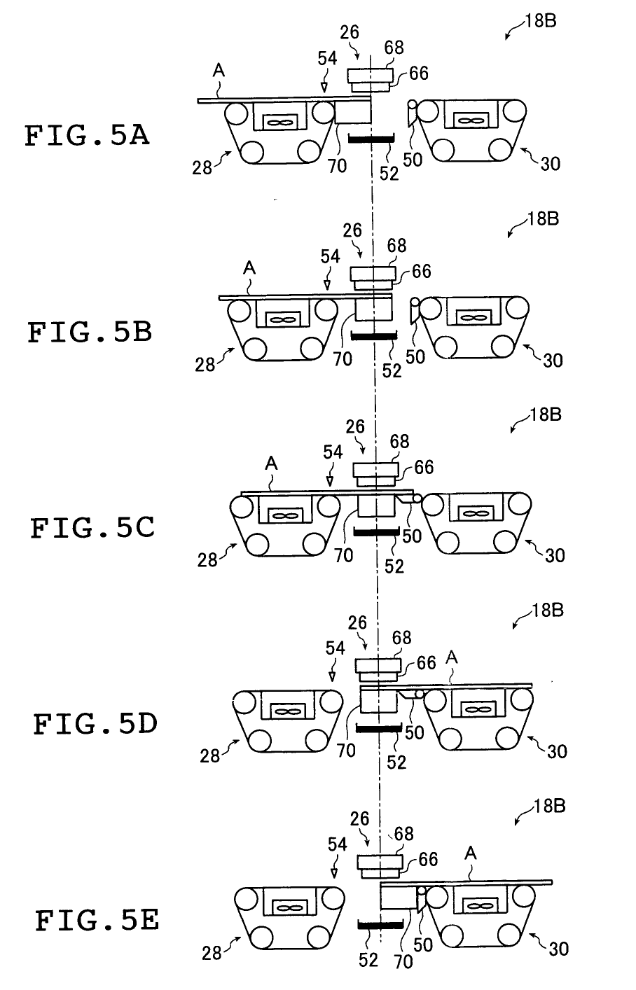

FIGS. 5A to 5E are block diagrams showing a configuration of an image recording section 18B in which an ink head 66 performing the division printing control is used and transport processes of the recording sheet during the image recording at the image recording section 18B. The image recording section 18B shown in FIGS. 5A to 5E has the same configuration as those in the above described embodiments except for the ink head 66, a recording unit 68, and a movable attraction stage 70, so the same components are given the same reference numerals and the explanations thereof are omitted.

In this embodiment, the control unit 56 (refer to FIG. 1) of the image recording section 18B causes the movable attraction stage 70 to move in the transport direction by the length corresponding to the division part from the position according to the division position where the ink head 66 is divided, and to stop at the position according to the division position.

The ink head 66 shown in FIGS. 5A to 5E is divided into two division parts in the transport direction, and performs two division printing in which ink is ejected on one line of a recording sheet twice. The position where the ink head 66 is divided (i.e., division position) is shown by a dashed line in the figures. Hereinafter, the upstream side of the ink head 66 (left side in FIGS. 5A to 5E) with respect to the dashed line is denoted as a first division region and the downstream side of the ink head 66 (right side in FIGS. 5A to 5E) is denoted as a second division region.

In the initial state shown in FIG. 5A, the movable attraction stage 70 is arranged so that the downstream edge thereof is located at the position that is on the upstream side of the division position of the ink head 66 by the length corresponding to one dot or more. In other words, the movable attraction stage 70 is arranged so that the downstream edge thereof is within the first division region. The guide surface of the handover guide plate 50 is retracted from the ink ejection region of the ink head 66.

When the front edge of the recording sheet A transported to the image recording section 18B accords with the downstream edge of the movable attraction stage 70, the upstream side attraction and transport subsection 28 stops the transport of the recording sheet A, and the image recording by the recording unit 68 is started onto the first line of the recording sheet A. Since the image recording is performed on the first line of the recording sheet A in a state where the front edge of the recording sheet A is within the first division region of the ink head 66, an image is recorded up to the front edge of the recording sheet A without leaving a margin, and the ink ejected outside the recording sheet A is collected into the ink receiver 52.

After scanning by the ink head 66, the movable attraction stage 70 is moved by the length of the division part of the ink head 66 in the transport direction as shown in FIG. 5B. Then, the image recording onto the first line of the recording sheet A is started in a state where the front edge of the recording sheet A is within the second division region of the ink head 66. At this time, the image recording is performed onto the second line of the recording sheet A by ejecting ink from the first division region of the ink head 66. In the above manner, an image of high density is recorded on the front end portion of the recording sheet A without leaving a margin.

When the front edge of the recording sheet A passes through the ink ejection region of the ink head 66, the handover guide plate 50 is rotated, so that the guide surface thereof is in the transport path as shown in FIG. 5C. The recording sheet A is guided by the handover guide plate 50 and is transported to the downstream side attraction and transport subsection 30 while being subjected to the image recording.

The image recording and the transport of the recording sheet A proceed in the above manner, and when the rear edge of the recording sheet A accords with the upstream edge of the movable attraction stage 70, the movable attraction stage 70 starts to move in the transport direction together with the recording sheet A. At this time, the handover guide plate 50 is retracted from the transport path.

The rear end portion of the recording sheet A is subjected to the image recording in a state where the rear edge of the recording sheet A is within the first division region of the recording unit 68 as shown in FIG. 5D, and is then subjected to the image recording in a state where the rear edge is within the second division region of the recording unit 68 as shown in FIG. 5E. Thus, an image is recorded on the rear end portion of the recording sheet A without leaving a margin, and the ink ejected outside the recording sheet A is collected into the ink receiver 52.

As described above, the ink jet recording apparatus of the present invention can be considered to have a configuration equal to that in which the ink receiver 52 moves according to the positions of the front and rear edges of the recording sheet A, so the division printing can be performed without leaving a margin on the front and rear end portions of the recording sheet A. Consequently, borderless printing can be performed with high quality on a recording sheet.

The control unit 56 (refer to FIG. 1) of the image recording section 18B controls each component based on the detection signal of the recording sheet A detected by the recording sheet detection sensor 54, so that the above operation of each component is performed.

The position at which the movable attraction stage 70 is stopped may be determined according to the number of the division parts. Even in the case where the ink head 66 is divided into three or more division parts, borderless printing can be performed with high quality in the same way as the above-described embodiment.

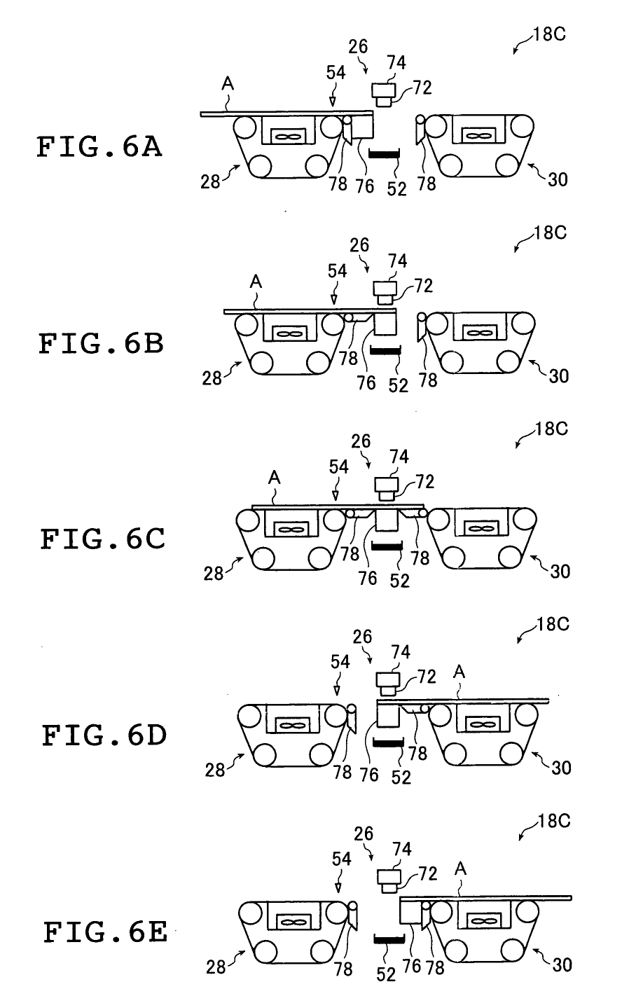

Next, an example of the configuration of the image recording section 18 in the case of using a line type ink head will be explained. FIGS. 6A to 6E are block diagrams showing a configuration of an image recording section 18C in which a line head is used and transport processes of the recording sheet A during the image recording. The image recording section 18C shown in FIGS. 6A to 6E has the same configuration as that shown in each of the above embodiments except for an ink head 72, a recording unit 74, a movable attraction stage 76, and guide plates 78, 78, so the same components are given the same reference numerals and the explanations thereof are omitted.

An ink head 72 is a line head comprising a nozzle line longer than the recording sheet A of the maximum width, that is the ink jet head of a so-called FWA (Full Width Array) system. The recording unit 74 performs the image recording in a state that the ink head 72 is arranged and fixed so that the nozzle line thereof accords with the width direction of the recording sheet A and the recording sheet A is continuously transported (for scanning) while performing the image recording.

The movable attraction stage 76 is moved between the upstream side and the downstream side with respect to the ink ejection region of the ink head 72 so that when the movable attraction stage 76 is on the most upstream side or the most downstream side, the movable attraction stage 76 is out of the ink ejection region of the ink head 72. Handover guide plates 78, 78 are arranged near the upstream side attraction and transport subsection 28 and the downstream side attraction and transport subsection 30, respectively, in the movable region of the movable attraction stage 76.

In the image recording section 18C, as shown in FIG. 6A, first, the movable attraction stage 76 is on standby at the position close to the upstream side attraction and transport subsection 28. The guide surfaces of the guide plates 78, 78 are retracted from the transport path.

When the front edge of the recording sheet A transported by the upstream side attraction and transport subsection 28 accords with the downstream edge of the movable attraction stage 76, under the control of the control unit 56 (refer to FIG. 1), the movable attraction stage 76 starts to move together with the recording sheet A as shown in FIG. 6B, and the guide plate 78 on the upstream side is moved into the transport path with the movement of the movable attraction stage 76 so as to support the recording sheet A.

The recording unit 74 starts to eject the ink from the ink head 72 right before the front edge of the recording sheet A is transported thereto. Thus, an image is recorded on the front end portion of the recording sheet A without leaving a margin, and the ink ejected outside the recording sheet A is collected into the ink receiver 52.

The control unit 56 stops the movement of the movable attraction stage 76 when the movable attraction stage 76 faces the ink head 72. In this state, the recording sheet A is continuously transported while keeping a flat state by being supported by the support surface of the movable attraction stage 76 and keeping a predetermined interval to the ink head 72. During the continuous transport of the recording sheet A, the image recording is continuously performed.

The recording sheet A having passed through the recording position is supported by the guide plate 78 on the downstream side having moved into the transport path as shown in FIG. 6C, and is handed over to the downstream side attraction and transport subsection 30.

When the image recording proceeds and the rear edge of the recording sheet A accords with the upstream edge of the movable attraction stage 76 as shown in FIG. 6D, the control unit 56 causes the guide plates 78, 78 on the upstream and downstream sides to be retracted from the transport path, and causes the movable attraction stage 76 to move together with the recording sheet A.

Finally, as shown in FIG. 6E, after the rear edge of the recording sheet A and the movable attraction stage 76 pass through the ink ejection region of the ink head 72, the ink ejection from the ink head 72 is stopped. Thus, an image is recorded on the rear end portion of the recording sheet A without leaving a margin, and the ink ejected outside the recording sheet A is collected into the ink receiver 52.

Accordingly, since the ink jet recording apparatus of the present invention comprises the movable platen, even when a line type ink head is used, borderless printing can be performed on a recording sheet with high quality.

Although the ink jet recording apparatus according to the present invention is described in detail above, the present invention is not limited to the above various embodiments, and it should be understood that various improvements and modifications are possible without departing from the gist of the present invention.

What is claimed is:

1. An ink jet recording apparatus comprising:
an ink jet recording head;
an upstream side transport unit that is arranged upstream of a recording position by the ink jet recording head and transports a recording sheet;
a downstream side transport unit that is arranged downstream of the recording position by the ink jet recording head and transports the recording sheet;
a platen arranged to be spaced apart from the ink jet recording head by a predetermined interval necessary for image recording, the platen being movable in a transport direction of the recording sheet between the upstream side transport unit and the downstream side transport unit;
a control unit controlling a movement of the platen; and
an ink receiver arranged to face the ink jet recording head across an ink ejection region of the ink jet recording head, the ink receiver receiving ink that was ejected from the ink jet recording head and passed across a position where the platen does not exist.

2. The ink jet recording apparatus according to claim 1, wherein the control unit controls the movement of the platen according to a position of the recording sheet transported by the upstream side transport unit or the downstream side transport unit.

3. The ink jet recording apparatus according to claim 1, further comprising a handover guide retractable between the platen and the downstream side transport unit for guiding the recording sheet.

4. The image recording apparatus according to claim 1, wherein the platen comprises an ink receiver that is arranged at a position corresponding to a width of the recording sheet and extends in the transport direction.

5. The image recording apparatus according to claim 1, wherein the platen is divided into regions in a width direction of the recording sheet so as to correspond to recording sheets of different widths, and the platen comprises suction holes for suctioning the recording sheet in the respective regions and suction paths for the suction holes of the respective regions, the suction paths are separated from one another.

6. The image recording apparatus according claim 1, wherein the ink jet recording head performs division printing, and the control unit determines a position to stop the platen according to a divided position of a division printing control by the ink jet recording head.
